(19) United States
(12) Patent Application Publication
(10) Pub. No.: US 2020/0114716 A1
(43) Pub. Date: Apr. 16, 2020

(54) MULTIPOINT CONTROL ARM

(71) Applicant: ZF Friedrichshafen AG, Friedrichshafen (DE)

(72) Inventors: Rainer UNGRUH, Hoerstel (DE); Markus WENZEL, Bersenbrück (DE); Arnold BLANKE, Damme (DE)

(21) Appl. No.: 16/493,132

(22) PCT Filed: Mar. 27, 2018
(86) PCT No.: PCT/EP2018/057697

§ 371 Date: Sep. 11, 2019

(30) Foreign Application Priority Data
Apr. 27, 2017 (DE) 10 2017 207 144.3

(51) Int. Cl. B60G 7/00

(52) U.S. Cl. CPC B60G 7/001; B60G 7/005; B60G 2206/7101; B60G 2206/73; B60G 2206/7103; B60G 2206/16; B60G 2206/7102

(57) ABSTRACT

a multipoint control arm having a metallic base body (6), with three or more joint holding openings (11, 12, 13), and a plurality of joints (3, 4, 5) which, in each case, are seated in a respective one of the joint holding openings (11, 12, 13). A first joint, or at least one first joint (3) has a joint housing (19) inserted into a corresponding joint holding opening (11) and an inner joint portion (20) which is fitted and able to move in the joint housing (19) and extends out of the latter. The metallic base body (6) and the joint housing (19) of the first joint (3) are both embedded in a casing body (7), made from a fiber-reinforced plastic.

This application is a National Stage completion of PCT/EP2018/057697 filed Mar. 27, 2018, which claims priority from German patent application serial no. 10 2017 207 144.3 filed Apr. 27, 2017.

### FIELD OF THE INVENTION

The invention relates to a multipoint control arm with a metallic base body, which has three or at least three joint holding openings and a plurality of joints, each seated in one of the joint holding openings, wherein one or at least a first one of the joints comprises in particular a joint housing seated in a corresponding joint holding opening, and an inner joint portion which is fitted and able to move, preferably being fitted in the joint housing and extending out of the latter. In addition the invention relates to a method for producing a multipoint control arm of this type.

### BACKGROUND OF THE INVENTION

In the wheel suspension of motor vehicles in particular, three-point (3-point) control arms are used. In serial applications, for example the 3-point control arms listed below are known:

a) control arms with housings made of cast-iron, steel or aluminum (produced by casting or forging);

b) control arms made of one-piece or multi-component sheet parts (welded designs);

c) hybrid control arms with a single shell-like sheet having injection-molded stiffeners/ribs of plastic.

The following work steps in particular are regarded as complicated and therefore disadvantageous for the production of 3-point control arms:
the mechanical machining of the control arm housing;
the formation of weld joints;
the provision of the control arm housing with surface protection.

### SUMMARY OF THE INVENTION

Starting from there the purpose of the present invention, in the case of a multipoint control arm of the type mentioned to begin with, is to be able to avoid one or more of the aforesaid disadvantages.

This objective is achieved by a multi-point control arm and method according to the independent claim(s). Preferred further developments of the multipoint control arm and of the method are indicated in the description that follows.

The multipoint control arm mentioned at the beginning, with a metallic base body, has three or at least three joint holding openings and a plurality of joints, each of which is seated in one of the joint holding openings, wherein one or at least a first one of the joints comprises an inner joint portion. In particular one or at least a first one of the joints has a joint housing inserted into a corresponding joint holding opening. The inner joint portion is in particular fitted and able to move in the joint housing. Preferably, the inner joint portion extends out of the joint housing. In particular, the multipoint control arm also has a casing body that consists of fiber-reinforced plastic,
in which the metallic base body and the joint housing of the first joint are embedded
or
in which the metallic base body is embedded, whereas by virtue of the casing body at the same time an integral joint housing is formed.

A control arm body of the multipoint control arm is preferably formed by the casing body and the base body embedded therein. The external design and/or the external appearance of the control arm body is in particular determined by the external design and/or by the external appearance of the casing body, which is or will be preferably produced by the injection-molding process. Accordingly, the external design and/or the external appearance of the control arm body can for example be predetermined or produced by an injection-molding die. Thus, in particular there is no need for any mechanical (finish-)machining of the control arm housing. Moreover, the joint housing can be embedded in the casing body and thereby secured therein, in particular with interlock. Thus, for example, a welding connection between the joint housing and the metallic base body for attaching the joint housing to the base body can be dispensed with. Preferably, the casing body also serves to protect the surface of the metallic base body. Thus, for example, there is no need to apply any additional surface protection to the metallic base body.

Alternatively, a joint housing can be formed by the casing body. This obviates the need for a separate joint housing. Instead, the joint housing is an integral or one-piece part of the casing body.

Furthermore, the possibility exists of functional integration. For example, a connection point for a sealing bellows of the first joint is or will be formed by the casing body. Such a connection point comprises for example an annular groove provided in the casing body, preferably around the joint housing and/or the inner joint portion. Preferably, the control arm body and/or the casing body has stiffening ribs, preferably on its/their outer surface, which in particular are or will be formed by the casing body and/or by the fiber-reinforced plastic. Advantageously, particularly during the production of the casing body, one or more electric or electronic assemblies and/or one or more electric conductors and/or one or more sensors, such as one or more height measurement sensors, are or will be embedded and/or integrated in the casing body. Preferably, particularly during the production of the casing body, one or more cable holders are or will be provided on the casing body, preferably injection-molded in place.

According to a further development, the joint holding opening associated with the first joint is or will be formed by a hole in the base body or by a recess provided in the base body. In particular, the joint housing of the first joint is inserted into this hole or recess, and/or press-fitted into it. The hole is for example a through-going hole.

In one embodiment the inner joint portion comprises a bearing area by virtue of which the inner joint portion is mounted in the joint housing. The bearing area is preferably spherical. Preferably, the first joint is or forms a ball joint or a ball sleeve joint. For example, the inner joint portion is or forms a ball stud, a ball component or a ball sleeve. Advantageously, associated with the inner joint portion there is an inner joint portion axis. Preferably, relative to the inner joint portion axis the inner joint portion is rotation-symmetrical or substantially so. Advantageously, the mid-point of the bearing area lies on the inner joint portion axis. Preferably, the inner joint portion is made of metal, in particular a ferrous material such as steel,

The inner joint portion is preferably fitted so that it can move by sliding in the joint housing. According to a further development the inner joint portion is fitted into the joint housing, preferably with its bearing area and with a bearing shell interposed, so that it can move and/or slide. Advantageously, with its bearing area the inner joint portion is fitted into the bearing shell, in particular so that it can slide. Preferably the bearing shell is made of plastic, in particular a thermoplastic material. For example the bearing shell consists of polyoxymethylene (POM), polyimide (PA) or polyetheretherketone (PEEK). The bearing shell is for example a spherical shell.

The joint housing preferably comprises one, or at least one housing opening through which the inner joint portion extends out of the joint housing. The joint opening is for example also called the stud opening, particularly when the inner joint portion is in the form of a ball stud. Preferably, the connection point for the sealing bellows and/or the annular groove is provided in the area of the housing opening. Advantageously, a joint housing axis is associated with the joint housing. Preferably, relative to the joint housing axis the joint housing is rotationally-symmetrical, or substantially so. Preferably, the mid-point of the bearing area lies on the joint housing axis. Advantageously, the joint housing axis extends through the housing opening, in particular centrally. The joint housing is preferably made of plastic or metal, in particular aluminum, magnesium or a ferrous material such as steel.

Advantageously, the joint housing is or will be partially or only partially embedded in the casing body. In particular, in the area of the housing opening the joint housing is clear of the casing body and/or the fiber-reinforced plastic. Preferably, in the area of the housing opening the joint housing is clear of the casing body and/or the fiber-reinforced plastic. Advantageously, the inner joint portion extends out of casing body. In particular, preferably by virtue of embedding the joint housing in the casing body the joint housing is or will be connected to the casing body and/or to the fiber-reinforced plastic with interlock and/or in a materially-merged manner.

The metallic base body preferably is or forms an integral and/or one-piece and/or monolithic and/or material-homogeneous component. Preferably the metallic base body is made from sheet-metal. For example, the metallic base body consists of a ferrous material such as steel. The casing body and the metallic base body embedded in the casing body, together, form in particular the, or a, control arm body. Preferably, the metallic base body is embedded completely in the casing body and/or in the fiber-reinforced plastic. The control arm body is also called, for example, the control arm housing.

The casing body is in particular made by injection molding and/or by the injection-molding process. Preferably, the casing body is an injection-molded component. For example, the metallic base body and the joint housing have or will have the fiber-reinforced plastic injection-molded around them. Preferably, the fiber-reinforced plastic is or will be injection-molded completely around the metallic base body. Advantageously, the fiber-reinforced plastic is or will be injection-molded partially, or only partially around the joint housing. In particular the housing opening is or will remain clear of the fiber-reinforced plastic. Preferably, by virtue of the injection-molding with fiber-reinforced plastic the joint housing is or will be connected with interlock and/or in a material-merged manner with the casing body and/or the fiber-reinforced plastic.

The fiber-reinforced plastic comprises in particular a plastic matrix with fibers embedded in it. The fibers are or include in particular short fibers and/or long fibers. Short fibers have for example a length of 0.1 mm to 1 mm. Long fibers have for example a length of 1 mm to 50 mm. Preferably the fibers are or include glass fibers and/or carbon fibers and/or aramide fibers. The plastic matrix consists for example of a thermoplastic or duroplastic plastic or a synthetic resin. Preferably the fiber-reinforced plastic is a thermoplast mixed with short and/or long fibers. In particular the plastic matrix and/or thermoplast consists of a preferably partially crystalline polyamide (PA). Preferably the casing body and/or the fiber-reinforced plastic surrounds and/or encircles and/or encloses the joints or the other joints and/or the joint holding openings associated with the joints or the other joints. Moreover, the casing body and/or the fiber-reinforced plastic is for example electrically insulating. This makes sense particularly when electric or electronic assemblies and/or sensors are integrated in the casing body and/or in the fiber-reinforced plastic.

In an embodiment the other joints, or two or at least two of the other joints or another two or at least another two of the joints, are or will in particular be in the form of rubber mountings, sleeve joints or ball sleeve joints. Preferably, the joints in the form of rubber mountings will in each case comprise an elastomeric mounting body and an inner mounting component, which is preferably—in particular at least partially—surrounded by the, or the respective elastomeric mounting body. Advantageously, the rubber mountings have in each case an outer sleeve that surrounds the, or the respective mounting body and/or the, or the respective inner mounting component. In particular, the inner joint component of each rubber mounting is connected to the, or the respective outer sleeve by way of the, or the respective elastomeric mounting body. Advantageously, the elastomeric mounting body of each rubber mounting is arranged between the, or the respective inner component and the, or the respective outer sleeve. Preferably, an inner mounting component axis is associated with the inner component of each rubber mounting. In particular, relative to the, or the respective inner mounting component axis the, or the respective inner mounting component of each rubber mounting is rotation-symmetrical or substantially rotation-symmetrical. Preferably, an outer sleeve axis is associated with the outer sleeve of each rubber mounting. In particular, relative to the, or the respective outer sleeve axis the outer sleeve of each rubber mounting is rotation-symmetrical or substantially so. For example, the outer sleeve of each rubber mounting is cylindrical or substantially cylindrical. Preferably, the inner mounting component of each rubber mounting is made of metal, in particular a ferrous material such as steel. Preferably, the outer sleeve of each rubber mounting is made of plastic or metal, for example aluminum, magnesium or a ferrous material such as steel. Preferably, the casing body and/or the fiber-reinforced plastic surrounds and/or encircles and/or encloses the rubber mounting(s) and/or the joint holding opening(s) associated with the rubber mounting(s). As an alternative, the above-mentioned further developments for rubber mountings can also be used as further developments of sleeve joints or ball sleeve joints used instead of rubber mountings.

The multipoint control arm preferably is or forms a three-point (3-point) control arm. In particular, the multipoint control arm and/or the control arm body and/or the metallic base body and/or the casing body, preferably in each case, is/are designed mirror-symmetrically or substantially mirror-symmetrically relative to a central plane of the control arm. Advantageously, the joint housing axis lies in the central plane of the control arm. Preferably, the inner joint portion axes and/or the outer casing axes extend perpendicularly to the central plane of the control arm. For example, the outer casing axes coincide and/or the outer casing axes lie, for example, on a common line.

According to a further development, the multipoint control arm and/or the control arm body and/or the metallic base body and/or the casing body, preferably in each case, have two arms which, particularly preferably, each merge into one another in a transition zone in which the first joint and/or the joint holding opening is or will be provided. At the free ends of the arms facing away from the, or the respective transition zone, preferably the other joints and/or the rubber mountings and/or the joint holding openings associated with the other joints and/or rubber mountings are or will be provided.

In an embodiment the joint holding openings associated with the other joints and/or rubber mountings are or will in each case be formed, respectively, by one or more ring bodies in which, preferably, the corresponding other joint and/or the corresponding rubber mounting is held. For example the ring body, or the more than one ring bodies, are or will be formed or composed of two half-rings which, in particular along a line passing through the mid-point of the half-rings, are offset relative to one another. In addition or alternatively, the ring bodies of the respective joint holding openings are offset relative to one another, for example along a line passing through the mid-point of the ring bodies.

Preferably each rubber mounting is or will be inserted and/or pressed into the corresponding joint holding opening, in particular with its outer casing and/or its elastomeric mounting body. Advantageously each rubber mounting, in particular by way of its elastomeric mounting body or its outer casing, is connected to the casing body in a material-merged manner.

The multipoint control arm is or will preferably be provided for a wheel suspension of a vehicle which is in particular a motor vehicle, for example a passenger car. Advantageously, the multipoint control arm is or will be built into the, or into a wheel suspension of the, or of a vehicle. Preferably, the inner joint portion of the first joint is or will be connected to a wheel carrier or stub axle of the, or of a vehicle. Advantageously, the multipoint control arm and/or the control arm body is connected by way of the other joints and/or by way of the rubber mountings to a vehicle body and/or an axle carrier and/or a subframe of the, or of a vehicle. In particular the inner mounting portions of the rubber mountings are or will be connected to the, or to a vehicle body and/or to the, or an axle carrier and/or to the, or a subframe of the, or a vehicle.

Furthermore, the invention relates in particular to a method for producing the multipoint control arm described above, wherein:
in a primary joint production step the first joint is produced,
in a secondary joint production step the other joints are produced,
in a base body production step the metallic base body is made and provided with the joint holding openings,
in a primary joint insertion step that comes after the primary joint production step and the base body production step, the first joint with its joint housing is/are inserted into the appropriate joint holding opening and/or into one of the joint holding openings,
in an embedding step that comes after the primary joint insertion step the, or a fiber-reinforced plastic is injection-molded around the base body and the joint housing, so that the casing body in which the metallic base body and the joint housing are embedded, is formed around them,
in secondary joint insertion step that comes after the secondary joint production step and the base body production step, the other joints are in each case inserted into the appropriate or into their corresponding joint holding openings and/or into another of the joint holding openings.

The method can be developed further in accordance with all the design features described in connection with the multipoint control arm. Furthermore, the multipoint control arm can be developed further in accordance with all the features explained in connection with the method. For example, the primary joint production step and the secondary joint production step can be combined in a single joint production step in which the joints are made.

The injection-molding, particularly in the embedding step, preferably takes place by or in an injection-molding process. Preferably the injection-molding, particularly during the embedding step, is carried out in an injection-molding die. Advantageously, particularly in the secondary joint insertion step, the other joints are pressed into the (or their) appropriate joint holding openings and/or into the other joint holding openings.

According to a first alternative the secondary joint insertion step takes place before the embedding step and/or the embedding step comes after the secondary joint insertion step. Thus, preferably, particularly in the embedding step the other joints have the fiber-reinforced plastic injection-molded around them together with the base body and the joint housing of the first joint.

In a second alternative, the secondary joint insertion step comes after the embedding step and/or the embedding step takes place before the secondary joint insertion step.

Preferably, the first joint is the, or is a ball joint. Preferably, the other joints are rubber mountings. For example the other joints each form a rubber mounting or one of the rubber mountings. Alternatively the other joints can be in the form of sleeve joints or ball sleeve joints.

Alternatively, the invention relates to a method for producing the above-described multipoint control arm, in which:
in a primary joint production step the inner joint portion of the first joint is produced,
in a secondary joint production step the other joints are produced,
in a base body production step the metallic base body is produced and provided with the joint holding openings,
in a primary joint insertion step that comes after the primary joint production step and the base body production step, the inner portion of the first joint is arranged in one of the joint holding openings,
in an embedding step after the primary joint insertion step fiber-reinforced plastic is injection-molded around the base body and the inner joint portion of the first joint, so that from the fiber-reinforced plastic the casing body, in which the metallic base body and a joint housing for the inner joint portion are embedded, is formed.

This method can be developed further in accordance with all the embodiments explained earlier.

Preferably, in a secondary joint insertion step that comes after the secondary joint production step and the base body production step, the other joints are inserted each into another of the joint holding openings.

### BRIEF DESCRIPTION OF THE DRAWINGS

Below, the invention is described with reference to preferred embodiments illustrated in the drawings, which show:

FIG. 1; A perspective view of a three-point control arm according to a first embodiment, which has a control arm body carrying a ball joint and two rubber mountings,

FIG. 2: A perspective view of a metallic base body for the first embodiment, with three joint holding openings,

FIG. 3: The view as in FIG. 2, in which the ball joint is inserted into one of the joint holding openings,

FIG. 4: A perspective view of a three-point control arm according to a second embodiment, which has a control arm body carrying a ball joint and two rubber mountings,

FIG. 5: A perspective view of a metallic base body for the second embodiment, with three joint holding openings,

FIG. 6: The view as in FIG. 5, in which the ball joint is inserted into one of the joint holding openings, and

FIG. 7: The view as in FIG. 6, in which, respectively, one of the rubber mountings is inserted into each joint holding openings.

### DETAILED DESCRIPTION OF THE PREFERRED EMBODIMENTS

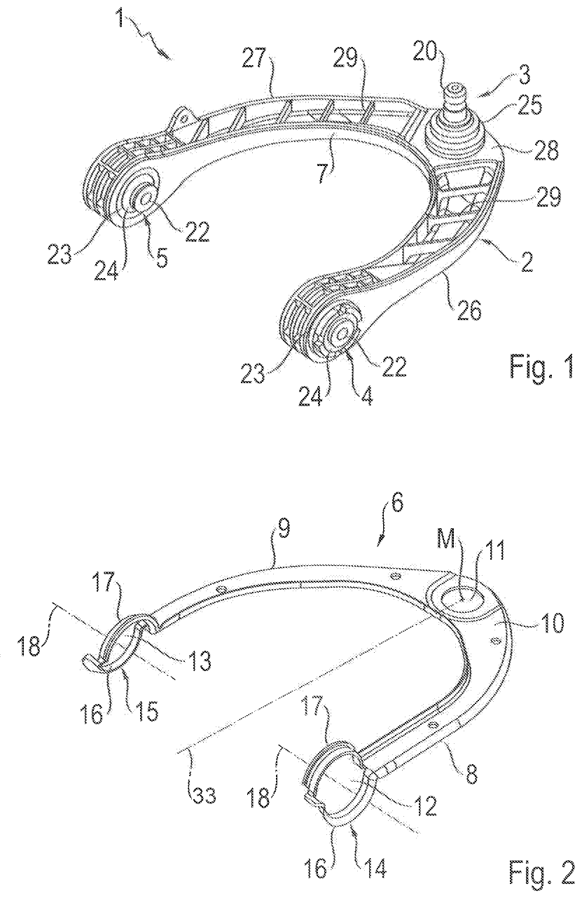

FIG. 1 shows a perspective view of a three-point control arm 1 according to a first embodiment, which comprises a control arm body 2 that supports a ball joint 3 and two rubber mountings 4 and 5. The control arm body 2 comprises a base body 6 made of sheet-metal, which can be seen in the perspective view of FIG. 2, the body being embedded in a casing body 7 consisting of fiber-reinforced plastic, which determines the external appearance of the control arm body 2.

The base body 6 has two base body arms 8 and 9 which merge into one another in a base body transition zone 10. In addition the base body 6 has three joint holding openings 11, 12 and 13, the joint holding opening 11 being in the form of a through-hole provided in the base body transition zone 10. The joint holding openings 12 and 13 are provided at the free ends of the base body arms 8 and 9 remote from the base body transition zone 10 and are each formed by a ring body 14 and 15 respectively, each ring body being formed of two half-rings 16 and 17 which, along a line 18 passing through their mid-point, are offset relative to one another. Moreover, the base body 6 is formed mirror-symmetrically relative to a central plane 33 of the control arm that passes through the mid-point M of the joint holding opening 11 and extends perpendicularly to the line 18, as illustrated only schematically.

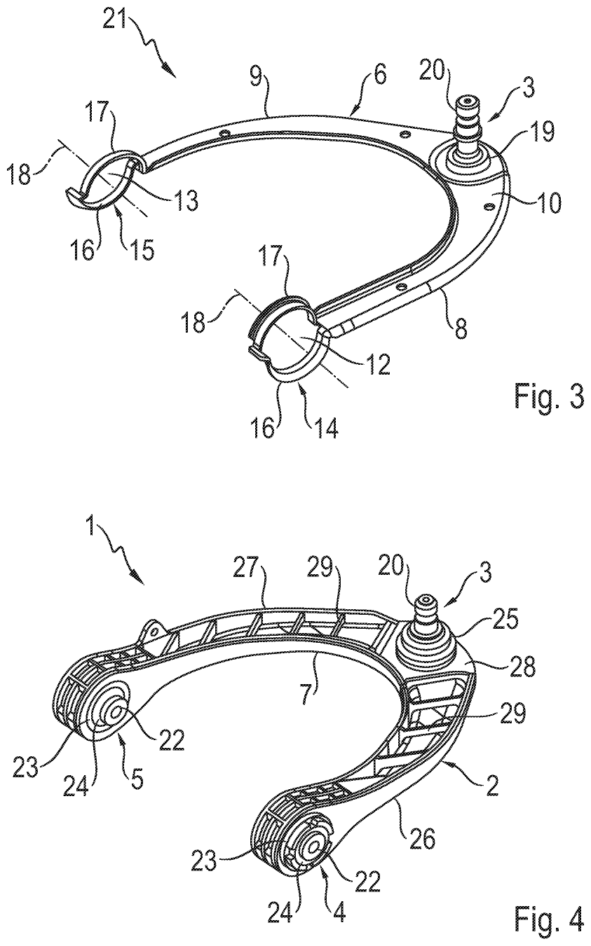

The ball joint 3 is inserted into the joint holding opening 11 of the base body 6, as can be seen in FIG. 3 which shows a perspective view of the base body 6 with the ball joint 3 inserted into the joint holding opening 11. It can also be seen in FIG. 3 that the ball joint 3 has a joint housing 19 and a ball stud 20. The ball stud 20 is fitted and able to move in the joint housing 19 and extends out of the latter. Furthermore the joint housing 19 is press-fitted into the joint holding opening 11 so that the ball joint 3 with its joint housing 19 is connected to the base body 6 by friction force. The assembly 21 so formed is placed into an injection-molding die and around it is injection-molded the fiber-reinforced plastic which, after hardening or setting, forms the casing body 7.

After that, the rubber mountings 4 and 5 are inserted into the joint holding openings 12 and 13, the rubber mountings in each case comprising an inner mounting portion 22, an outer sleeve 23 surrounding the inner mounting portion 22 and, between the inner mounting portion 22 and the outer sleeve 23 an elastomeric mounting body 24, by means of which the inner mounting portion 22 is connected to the outer sleeve 23. The rubber mountings 4 and 5 with their outer sleeves 23 are in each case press-fitted into the respective joint holding openings 12 or 13. Finally, a sealing bellows 25 too is fitted onto the ball joint 3.

From FIG. 1 it can also be seen that the control arm body 2 has two control-arm arms 26 and 27, which merge into one another in a control arm body transition zone 28 in which the ball joint 3 is seated. The joint housing 19 of the ball joint 3 is embedded in the casing body 7 and is therefore secured therein with interlock. At the free ends of the control-arm arms 26 and 27 remote from the control arm body transition zone 28 the rubber mountings are provided, and the joint holding openings 12 and 13 are surrounded by the casing body 7. Furthermore the control arm body 2 has stiffening ribs 29 formed by the casing body 7. In particular, relative to its central plane 33 the control arm body 2 is mirror-symmetrical.

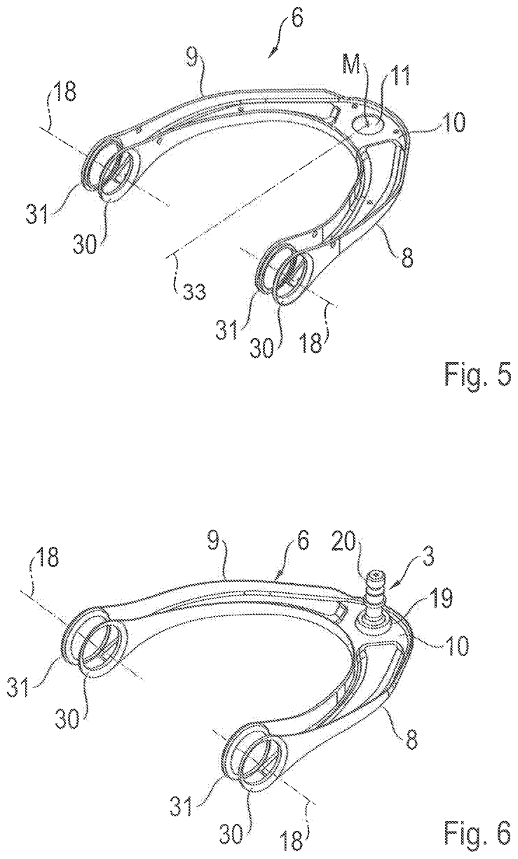

FIG. 4 shows a perspective view of a three-point control arm 1 according to a second embodiment. In the figure features identical or similar to those in the first embodiment are denoted by the same indexes as in the first embodiment. The three-point control arm 1 according to the second embodiment comprises a control arm body 2 which carries a ball joint 3 and two rubber mountings 4 and 5. The control arm body 2 has a base body 6 made of sheet-metal, shown in perspective in FIG. 5, which is embedded in a casing body 7 consisting of fiber-reinforced plastic, which determines the external appearance of the control arm body 2.

The base body 6 has two base body arms 8 and 9, which merge into one another in a base body transition zone 10. In addition the base body 6 has three joint holding openings 11, 12 and 13, of which the joint holding opening 11 is provided in the form of a through-hole in the base body transition zone 10. The joint holding openings 12 and 13 are provided, respectively, at the free ends of the base body arms 8 and 9 remote from the base body transition zone 10 and are in each case formed by ring bodies 30 and 31 which, along a line 18 passing through their mid-points, are offset relative to one another. Moreover, relative to a central plane 33 of the control arm that passes through the mid-point M of the joint holding opening 11 and is perpendicular to the line 18, the base body 6 is mirror-symmetrically formed as is illustrated only schematically.

The ball joint 3 is inserted into the joint holding opening 11 of the base body 6, as shown in FIG. 6 which is a perspective view of the base body 6 with the ball joint 3 inserted into the joint holding opening 11. In addition it can also be seen in FIG. 6 that the ball joint 3 has a joint housing 19 and a ball stud 20. The ball stud 20 is fitted and can move within the joint housing 19, out of which it extends. Moreover, the joint housing 19 is press-fitted into the joint holding opening 11 so that the ball joint 3, with its joint housing 19, are connected to the base body 6 by friction force.

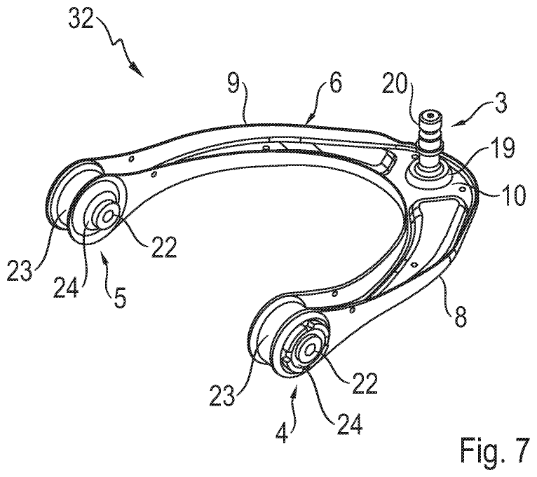

Thereafter, the rubber mountings 4 and 5 are inserted into the joint holding openings 12 and 13 of the base body 6, as shown in FIG. 7 which is a perspective view of the base body 6 with the ball joint 3 inserted into the joint holding opening 11 and the rubber mountings 4 and 5 inserted, respectively, into the joint holding openings 12 and 13. In this case the rubber mountings 4 and 5 each have an inner mounting portion 22, an outer sleeve 23 surrounding the inner portion 22 and, between the inner portion 22 and the outer sleeve 23, an elastomeric mounting body 24 by means of which the inner portion 22 is connected to the outer sleeve 23. In particular, the rubber mountings 4 and 5 are in each case press-fitted with their outer sleeves 23 into the respective joint holding openings 12, 13.

Then the assembly 32 so formed is placed in an injection-molding die and the fiber-reinforced plastic is injected around it; after this has hardened or set, it forms the casing body 7. Finally, a sealing bellows 25 is also fitted onto the ball joint 3,

From FIG. 4 it can be seen that the control arm body 2 too has two control arm body arms 26 and 27, which merge into one another at a control arm body transition zone 28 in which the ball joint 3 is seated. The joint housing 19 of the ball joint 3 is embedded in the casing body 7 and therefore secured therein with interlock. At the free ends of the control arm body arms 26 and 27 remote from the control arm body transition zone 28, the rubber mountings 4 and 5 are provided, the joint holding openings 12 and 13 being surrounded by the casing body 7. In this case the outer sleeves 23 of the rubber mountings are connected to the casing body 7 in a material-merged manner. Furthermore, the control arm body 2 has stiffening ribs 29 formed by the casing body 7. In particular, this control arm body 2 also is formed mirror-symmetrically relative to the central plane 33 of the control arm.

### INDEXES

1 Three-point control arm
2 Control arm body of the three-point control arm
3 Ball joint
4 Rubber mounting
5 Rubber mounting
6 Base body of the control arm body
7 Casing body of the control arm body
8 Arm of the base body
8 Arm of the base body
10 Transition zone of the base body
11 Joint holding opening/through-hole
12 Joint holding opening
13 Joint holding opening
14 Ring body
15 Ring body
16 Half-ring
17 Half ring
18 Line
19 Joint housing of the ball joint
20 Ball stud of the ball joint
21 Assembly comprising the base body and the ball joint
22 Inner portion of the rubber mounting
23 Outer sleeve of the rubber mounting
24 Elastomeric mounting body of the rubber mounting
25 Sealing bellows
26 Arm of the control arm body
27 Arm of the control arm body
28 Transition zone of the control arm body
29 Stiffening ribs on the control arm body
30 Ring body
31 Ring body
31 Assembly comprising the base body, the ball joint and the rubber mountings
33 Central plane of the control arm
M Mid-point of the through-hole

1-16. (canceled)

17. A multipoint control arm comprising:
a metallic base body (6) having at least three joint holding openings (11, 12, 13),
a plurality of joints (3, 4, 5), and each one of the plurality of joints being seated in a respective one of the joint holding openings (11, 12, 13),
at least a first one of the plurality of joints (3) having an inner joint portion (20) which is movably mounted,
a casing body (7) made of fiber-reinforced plastic, and
one of:
the metallic base body (6) and a joint housing (19) of the first joint (3) being embedded within the casing body, or
the metallic base body (6) being embedded, by virtue of the casing body (7), at the same time an integrated joint housing is formed.

18. The multipoint control arm according to claim 17, wherein the joint holding opening (11) associated with the first joint (3) is formed by a hole provided in the base body (6), into which the joint housing (19) of the first joint (3) is inserted or pressed.

19. The multipoint control arm according to claim 17, wherein the first joint (3) is a ball joint, and the inner joint portion thereof is a ball stud.

20. The multipoint control arm according to claim 17, wherein second and third joints (4, 5) of the plurality of joints are one of sleeve joints, ball sleeve joints or rubber mountings, and each the second and the third joints comprises an elastomeric mounting body (24) and an inner mounting portion (22) at least partially surrounded by the mounting body (24).

21. The multipoint control arm according to claim 20, wherein the rubber mounting of each of the second and the third joints (4, 5) has an outer sleeve (23) that surrounds the mounting body (24) thereof.

22. The multipoint control arm according to claim 20, wherein the casing body (7) surrounds the joint holding openings (12, 13) associated with the rubber mountings of the second and the third joints (4, 5).

23. The multipoint control arm according to claim 20, wherein the joint holding openings (12, 13), associated with the rubber mountings of the second and the third joints (4, 5), are formed, in each case, by one or more ring bodies (14, 15; 30, 31) provided on the base body (6), in which the respective rubber mounting is seated.

24. The multipoint control arm according to claim 23, wherein the one or more ring bodies (14,15) are, in each case, formed of two half-rings (16, 17) which, relative to a line (18) passing through mid-points thereof are offset from one another.

25. The multipoint control arm according to claim 20, wherein the rubber mounting of each of the second and the third joints (4, 5) is connected, in a materially-merged manner, to the casing body (7) by way of the mounting body (24) thereof or an outer sleeve (23).

26. The multipoint control arm according to claim 17, wherein the fiber-reinforced plastic is a thermoplast mixed with relatively short fibers.

27. The multipoint control arm according to claim 17, wherein the fiber-reinforced plastic is injection-molded around the metallic base body (6) and the joint housing (19).

28. A method of producing a multipoint control arm having a metallic base body (6) with at least three joint holding openings (11, 12, 13) and a plurality of joints (3, 4, 5), each one of the plurality of joints being seated in a respective one of the joint holding openings (11, 12, 13), at least a first one of the plurality of joints (3) having an inner joint portion (20) which is movably mounted, a casing body (7) made of fiber-reinforced plastic, and either: the metallic base body (6) and a joint housing (19) of the first joint (3) being embedded within the casing body, or the metallic base body (6) being embedded, by virtue of the casing body (7), at the same time an integrated joint housing is formed, the method comprising:
making the first joint (3) during a primary joint production step;
making at least second and third joints (4, 5) of the plurality of joints during a secondary joint production step;
making the metallic base body (6) and providing the metallic base body with the at least three joint holding openings (11, 12, 13) during a base body production step;
inserting the first joint (3) with its joint body (19) into one of the at least three joint holding openings (11) during a primary joint insertion step that comes after the primary joint production step and the base body production step;
during an embedding step that comes after the primary joint insertion step, injection molding the fiber-reinforced plastic molded around the base body (6) and the joint housing (19) of the first joint (3), such that the casing body (7) in which the base body (6) and the joint housing (19) are embedded is formed from the fiber-reinforced plastic; and
inserting each of the second joint and the third joint (4, 5) into other openings of the at least three joint holding openings (12, 13), during a secondary joint insertion step that comes after the secondary joint production step and the base body production step.

29. The method according to claim 28, further comprising performing the secondary joint insertion before the embedding step, so that during the embedding step the fiber-reinforced plastic is injection-molded around the second and the third joints (4, 5) together with the base body (6) and the joint housing (19) of the first joint (3).

30. The method according to claim 28, further comprising pressing the second and the third joints (4, 5) into the other openings of the at least three joint holding openings (12, 13) during the secondary joint insertion step after the embedding step.

31. The method according to claim 28, further comprising forming the first joint (3) as a ball joint and forming the second and the third joints as rubber mountings.

32. A method of producing a multipoint control arm having a metallic base body (6) with at least three joint holding openings (11, 12, 13) and a plurality of joints (3, 4, 5), each one of the plurality of joints being seated in a respective one of the joint holding openings (11, 12, 13), at least a first one of the plurality of joints (3) having an inner joint portion (20) which is movably mounted, a casing body (7) made of fiber-reinforced plastic, and either: the metallic base body (6) and a joint housing (19) of the first joint (3) being embedded within the casing body, or the metallic base body (6) being embedded, and by virtue of the casing body (7), at the same time an integrated joint housing is formed, the method comprising:
making the inner joint portion (20) of the first joint (3) during a primary joint production step;
making second and third joints (4, 5) of the plurality of joints during a secondary joint production step;
making the metallic base body (6) and providing the metallic base body with the at least three joint holding openings (11, 12, 13) during a base body production step;
arranging the inner joint portion (20) of the first joint (3) in one of the joint holding openings (11) during a primary joint insertion step that comes after the primary joint production step and the base body production step; and
during an embedding step that comes after the primary joint insertion step, injection molding the fiber-reinforced plastic around the base body (6) and the inner joint portion (20) of the first joint (3), such that the casing body (7), in which the metallic base body (6) is embedded, and the joint housing (19), for the joint inner portion (20) of the first joint (3), are formed from the fiber-reinforced plastic.
